(19) United States
(12) Patent Application Publication
(10) Pub. No.: US 2019/0280854 A1
(43) Pub. Date: Sep. 12, 2019

(54) SKILLS PASSPORT BLOCKCHAIN PLATFORM

(71) Applicant: VIRIDIS LEARNING, INC., New York, NY (US)

(72) Inventors: Sudhir WADHWA, New York, NY (US); Felix ORTIZ, New York, NY (US)

(21) Appl. No.: 16/298,750

(22) Filed: Mar. 11, 2019

Related U.S. Application Data
(60) Provisional application No. 62/640,980, filed on Mar. 9, 2018.

(51) Int. Cl. H04L 9/06; H04L 9/32; G06F 16/953

(52) U.S. Cl. CPC H04L 9/0637; H04L 2209/38; G06F 16/953; H04L 9/3213

(57) ABSTRACT

The embodiments disclosed herein relate networks interacting with an architecture to receive, store, disseminate, and access personal curriculum vitae data in a ledger. In some examples, the storage includes blockchain architecture to encrypt ledger entries. In some example embodiments, a back end system is arranged to provide access for academic institutions and stakeholder users to write to the ledgers, thereby controlling access.

### CROSS REFERENCE

This application relates to and claims priority from U.S. Provisional application 62/640,980 filed 9 Mar. 2018, the entirety of which is hereby incorporated by reference.

### FIELD

This application relates to the field of computing devices, computer networks, blockchain ledgers, and data processing.

### BACKGROUND

Current data sharing regarding skills training of individuals and groups is limited to social networks and self-published information. Such information is inherently unreliable and unverified. Further, there is a need to incentivize the use of verifiable ledger creation and adoption. The current systems are unverified, disparate, and inherently suspect.

### SUMMARY

System and methods here may include using a computer with a processor and memory, communicating over a network, to provide access to a user to send curriculum vitae data into a profile, where the profile is written as a blockchain ledger, receive the curriculum vitae data of the user, analyze the received curriculum vitae data for the user to determine a correlated third party associated with the curriculum vitae data, contact the correlated third party, by the network, regarding the input curriculum vitae data for the user, provide access to the third party, over the network, to write to the blockchain ledger profile of the user, and disseminate the written blockchain ledger to a plurality of node computers, by the network. In some examples, alternatively or additionally, the access to the blockchain ledger is by a coin. In some examples, alternatively or additionally, the blockchain ledger is encrypted. In some examples, alternatively or additionally, the third party is at least one of an online university, university, school, company, or government entity. In some examples, alternatively or additionally, the computer is further configured to, receive a query from a query user, by the network, the query regarding curriculum vitae data, search the blockchain ledger of the user, using the received query; send search results to the query user, by the network. In some examples, alternatively or additionally, the computer is further configured to, receive curriculum vitae data of a plurality of other users, search the blockchain ledgers of the user and the plurality of other users, using the received query, and send search results to the query user, by the network. In some examples, alternatively or additionally, the computer is further configured to, provide to the user, over the network, the ability to allow only a subset of the input curriculum vitae data to be found in a search.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an example network architecture used to implement the methods described herein.

FIG. 2 is an example blockchain architecture used to implement the methods described herein.

FIG. 3 is an example hardware/software architecture used to implement the methods described herein.

FIG. 4 is an example computer components which may be used to implement the methods described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

The current available skills sharing systems are implemented with self-published data which is inherently unreliable. Systems and methods here include a Skill Passport blockchain Platform (SPM) that act as a decentralized education and work/Skill profile (e.g. curriculum vitae—CV) platform. The system may allow participants to build a data profile for storage, sharing, and to submit for verification. Such a system solves the technological problems with other paper CVs or even other online CV sharing websites, because the systems and methods here provide users far more control over their data input which can be then verified to provide to others in a fully trusted manner.

For example, users create their own CVs and share and post them on websites as well as job submission sites. But third parties looking to hire these individuals may have trouble vetting the CVs in an economical manner. There is no easy way to fact check student and employment credentials without much effort such as contacting the companies involved, which is a cost and time consuming process. Further, once an employee has left a particular company or school, there is very little that the former employer or school can say about the performance and responsibilities of the employee user without breaching data privacy rules. Thus, user CV criteria such as job responsibilities and underlying skills are areas that may go unverified.

The systems and methods here remedy these deficiencies by providing a permissioned blockchain network, arranged between a back end system and networked users. These users are the data sharers or stakeholders, who share their own credential information by populating their data onto the system, and associating that data with their profile. This populated credential information is then verified by certain institutions which were involved with awarding or granting the credential information, thereby verifying the information. These profiles may be mined for information, shared with third party requesters, and used for statistical gathering. Further, as described herein, using the blockchain, the data input into the system may be verified and thereby trusted.

Overview of Private Blockchain Architecture

Systems and methods here provide for a private Blockchain network between a back end system administrator and other stakeholder users who may share their own information. In some example embodiments, this may be their credential information, such as CV or resume type information. Any of various information could be shared using the systems and methods here, and CV examples are not intended to be limiting.

In the system, a virtual machine, referred to as a High Performance Appliance (HPA), designed for use in this specific blockchain system, will be managed and issued only by the back end system administrator. Participating stakeholder users are required to use the issued HPA to access and connect to the permissioned blockchain network and upload their information for storage. In other words, the blockchain architecture described herein is private, blocked, or otherwise hidden from use by the public. No access to the underlying records may be had without an instantiation of an HPA, and only an HPA issued by the back end system administrator.

In the example, employers (both external and internal to a company) looking to access the information from the platform, such as CV information for potential employees, will be able to access the information through services hosted by the back end system administrator. An application interface, separate and apart from the HPA, may be provided by the back end system administrator, to allows employers and other stakeholders to connect and invoke the services like sharing information. The application interface can simply be a mobile App on a mobile device, as described herein.

In the example, the back end system administrator may also provide services, through an application interface or an app, that can allow network participants to share and manage relevant information. Through use of role-based securities and access control lists, participants may control what information they want to publish to the network. The back end system administrator can then act as the blockchain network starter and owner, and decide the rules for onboarding a new member onto the network. Proof-of-Authority based consensus mechanisms may be used to commit the data onto the network. The HPA may be configurable for identity management of each participating stakeholder and establishing communication protocols.

In some example embodiments, blockchain based smart contracts may be created for user stakeholders to enter into an agreement to share their relevant CV information, for example. The back end system administrator may be one owner of the smart contract, the other user stakeholder may be another owner of the smart contract (network participants).

And in some examples, through encryption services embedded inside HPA, information submitted by network participants may be encrypted and then published onto blockchain ledgers as described herein. Using the decryption key, the back end system administrator may be able to decrypt the information at the application interface layer. Identity management of network participants may happen through a unique public/private key generated for each HPA. The HPA may physically save the private key for corresponding stakeholders and will be used for signing the transactions published to the blockchain ledger. The back end system administrator may host one of the nodes on cloud to have continuous information availability.

Network and Blockchain Examples

As described herein, the backbone of the systems and methods here is a blockchain architecture which may be used in a Skill Passport™ setting to submit CV credential information, verify such information through independent third-parties that provide the underlying credentials, then disseminate the information appropriately when called upon by requesters.

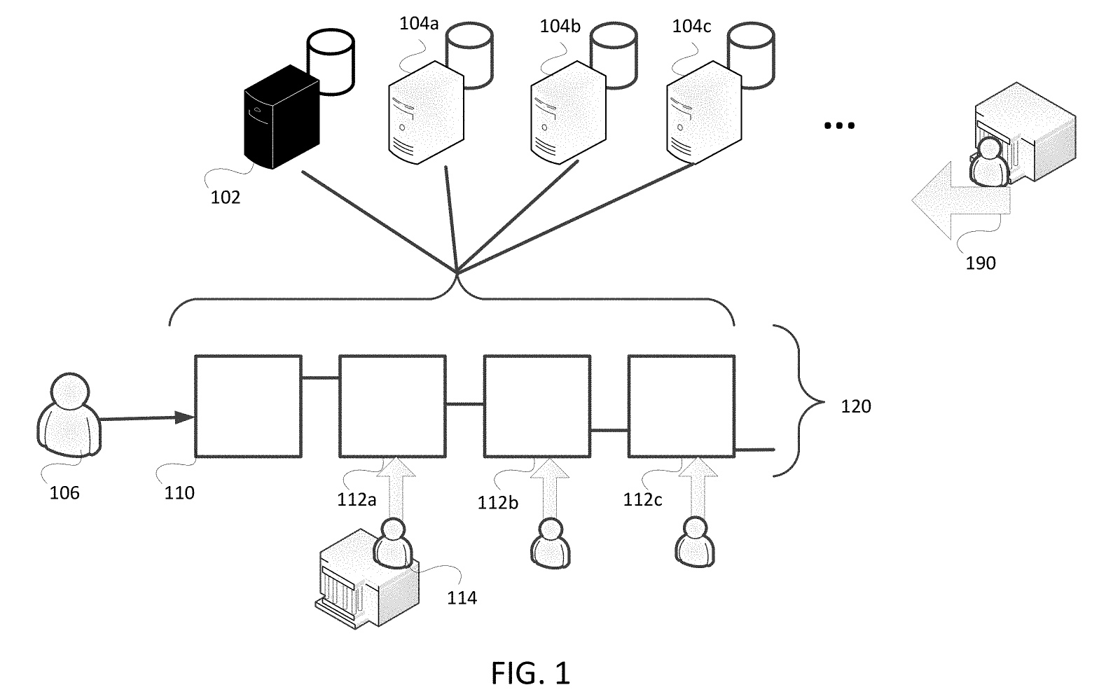

FIG. 1 shows a high level example of such a blockchain architecture, in this Skill Passport/CV setting to verify, from the institutions which provide the academic, employment, or honorary credentials at the very source. As explained herein, this verification system can allow for later parties to rely upon the user data in a verified way which has never been accomplished before. It should be noted that the “transaction” may not necessarily be a sale. For example, in the example using a CV, the ledger 120 may be an accumulation of credentials for a particular user 106. Each academic institution 114, for example, creates a transaction on the ledger 120 when it adds its verified credential to a particular user's ledger CV 120 as described herein. In some examples, each ledger entry may made by an academic institution, for any number of students, and the system then retains those blocks for later reference.

In the example, 106 is a typical stakeholder user, one who wishes to establish their own profile page, share CV data, and otherwise keep track of verified Skill Passport information as described herein. Typical CV information may be submitted to the back end system 102, such as but not limited to, academic institutions attended, classes taken, grades achieved, honors received, degrees/programs completed, wage data, and other employment history. Further, more fulsome information may be submitted as well, in order to provide a better picture about the users as whole people. Information such as attendance records, group participation, sports participation, society and club leadership roles may be a part of a users' experience that they want to portray to any of various third parties.

CV submission is a good way to promote oneself to any of various potential employers, academic institutions, and even honorarium societies. But there is an inherent untrustworthiness which may come along with CV creation and circulation. Unfortunate exaggeration of credentials may creep into user's CVs, and sometimes fully fraudulent degrees and grades appear on records. Such inherently unverified and potentially misleading information may be relied upon by any of various institutions, to their own detriment.

In the example, a transaction is memorialized 110 in the blockchain ledger as described herein. The example transaction 110 could be any number of things including a sale, a data write, or any of various contractual agreements, as described. In the example of CV submission and Skills Passports, the transaction may be an upload of a particular skill or credential that the stakeholder user 106 has accomplished in her life. For example, the user 106 indicates in her own profile that she attended State University. This information is then submitted to the blockchain ledger which is hosted by the back end system 102. The information is a claim that user 106 has attended a particular university, which is still unverified at the time of submission. The back end system, 102, which hosts the blockchain ledger 120 as described here, contacts or otherwise communicates with the third party institution indicated by the user 106, in this case, State University 114. The third party institution then verifies whether they have a record of individual user 106, and whether the credentials they have submitted to their profile are accurate. If the submission is verified, the third party 114 is allowed to write a block of the blockchain 112a which indicates that the entry by the user 106 is verified. The State University 114 may also augment the information provided, such as adding grades, or extra-curricular activities to the ledger 112a for the particular user 106. In some examples, the third party State University submits a multitude of students credentials to the system at once. In such an example, the back end system 102 would find the information regarding the user 106 to which the block write relates to, and later be able to search and produce information regarding this particular user 106.

In the example, the only way that the State University 114 is able to write to a block, is through the HPA virtual machine, which was provided by the back end system administrator 102. No third party in the public may write to a block, without their own HPA. This ensures that only verified information is being written in a block from the source of the credentials, in this case, from the university itself.

In some examples, omissions or mistakes may be written. For example, a student 106 indicates a grade in their profile 110 which is inaccurate. When the university 114 writes to the block 112a, with the verified grade information, that information then replaces the old write, but doesn't erase it. There is no way to erase an entry in the block, but new data may stand in its place. In this way, the blockchain records are immutable and unalterable, yet mistakes may be corrected in a particular manner.

The information in the transaction memorial blockchain write 110, Pp12a, etc. is encrypted and only the two parties in the transaction have the keys, as do the system administrator 102. Also shown in FIG. 1 are various nodes, or decentralized computer resources 104a-104c such as servers with processors and memories, networked in communication with one another. A back end system administrator 102 may also be used in some example embodiments. The transaction memorial block entry 110, once written, is copied to every node in the system 102, 104a-104c, or to as many nodes as can be reached. This method is a Proof-of-Authority method in a decentralized network. In some examples, the transaction memorial 110 is copied to at least 50% of the nodes 104a-104c in the system. These nodes 104a-104c store the encrypted transaction memorial 110 and although cannot necessarily access the contents or underlying data within the encrypted information, store and keep it. This creates a ledger 120 which is decentralized and stored on any of various nodes 104a-104c.

When another transaction occurs 112b, that transaction memorial blockchain write 112 is likewise encrypted and promulgated to the nodes 104a-104c. In this way, each ledger 120 is still stored in a decentralized manner, and still encrypted. Any number of transaction memorials 112a-112c. etc. could be added to the ledger 120, encrypted and stored in the nodes 104a-104c.

In some examples, a back end system administrator 102 is used to add a level of centralization and verification to the system. In such examples, the primary node 102 may act not only as a node storing the encrypted ledger 120, but also as a gatekeeper for information data being written into the ledger 120 at the various transaction memorials 110, 112a-Pp12c, etc. In such examples, not any party may be allowed to transact and write into a ledger 120, but instead, the primary node 102 controls access by providing encryption access by providing the only way that a third party can write to a block, through an HPA. In a CV example, the back end system 102 which allows only actual academic institutions to participate in the building of an online user 106 CV. In such a way, only credentialed academic institutions participating in the system are given HPAs and allowed in by the HPA to write to the blockchain 120 regarding the user CV ledgers. And by using this gatekeeper arrangement with the HPA, the back end system administrator 102 may access the ledgers 120, in order to publish the data, share the data, cultivate the data and/or otherwise search and utilize the data in the ledgers 120.

FIG. 1 also shows an example third party query user or requester 190 submitting a query or request to the system 102. This request or query could be for any information contained in any of the blockchain ledgers 120 from the one user 106, or any of the various others users who each have their own blockchain ledger CV profile on the system. In such examples, the backed system 102 may search, filter, compile, or otherwise review the data contained in any of the blockchain ledgers 120 for the requested or queried 190 information. In the CV example, the requester 190 may be a potential employer who has a list of candidate attributes it requires for a job, for example, a masters in physics. The system 102 is able to search all of the blockchain ledgers 120 for this query and return a result of certain users 106 who match, or any iteration of data in any combination, from any of the blocks in the blockchain database.

In some example embodiments, the system 102 may allow for users 106 to upload data to their blockchain ledger 120 profile, but not necessarily make all of that information available for every outside search query 190. In this way, users 106 may have more control over the release of their personal information than is otherwise possible. For example, there may be some demographics information that a particular user 106 does not want revealed in the first query by an outside party 190. In such examples, the system 102 can tailor the search and search results, and take into account any and all of the customizable search constraints put in place by individual users 106.

Proof-of-Authority (PaA): In PoA-based networks, transactions and blocks are validated by approved accounts, known as validators. Validators run software allowing them to put transactions in blocks. The process is automated and does not require validators to be constantly monitoring their computers. It, however, does require maintaining the computer. With PoA individuals earn the right to become validators, so there is an incentive to retain the position that they have gained. By attaching reputation to identity, validators are incentivized to uphold the transaction process, as they do not wish to have their identities attached to a negative reputation. This is considered more robust. PoA only allows non-consecutive block approval from any one validator, meaning that the risk of serious damage is minimized. PoA is suited for private networks but not for public networks where trust should be distributed. Systems and methods here may employ PoA.

In some example embodiments, a Proof-of-Authority based consensus mechanism will be used to commit the data onto the network. In such examples, a majority of nodes 104a-104c etc. may need to verify a ledger 120 before it is utilized by the system 102. Such an arrangement eliminates the possibility, statistically, that an erroneous or unverified entry into a ledger 120 may be promulgated. This is because, many copies of the ledger 120 are disbursed, there could be little chance for an operative to find and manipulate each of them in the same way, thus preserving the verified and true ledger in the disbursed, decentralized system.

In some examples, the HPA interface may be configurable for identity management of each participating stakeholder 106 and establishing communication protocols

System Utilization Examples

Additionally, or alternatively, the HPA interface may allow access to the system by third parties looking to write data to the blocks and the API allows third parties to utilize the underlying data in the Blockchain ledgers. For example, in a CV example, a potential employer may wish to access the verified CV of a user through the system. This HPA interface may allow for access to the information, as controlled by the back end system.

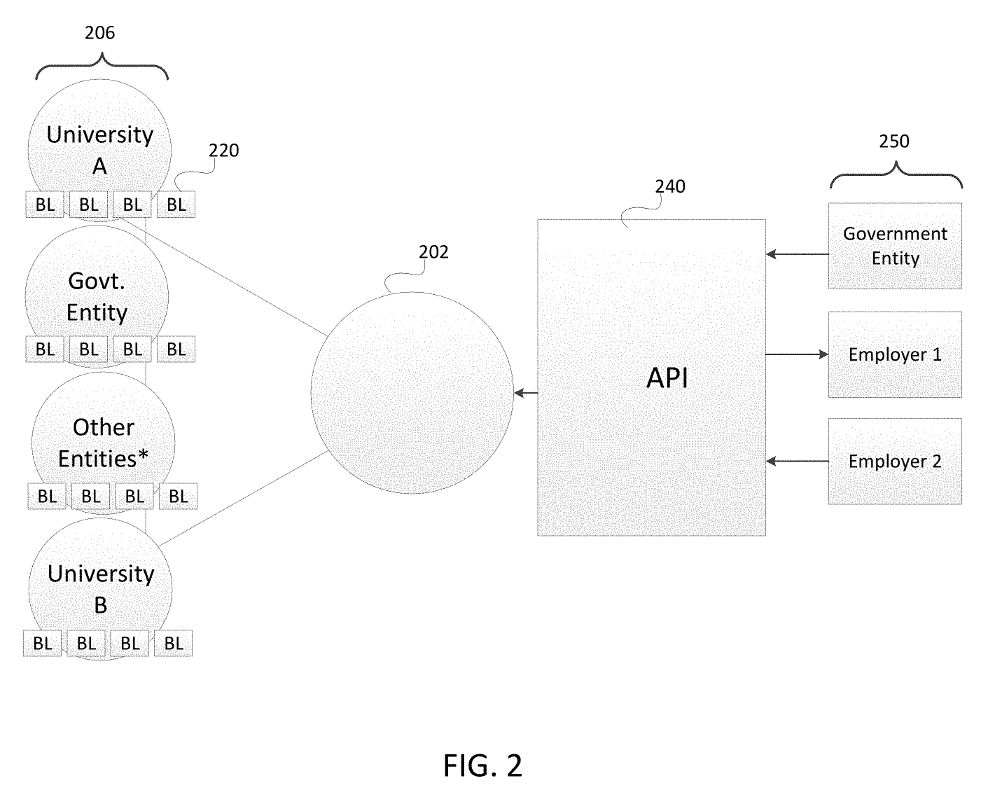

FIG. 2 shows another example of the overall system architecture. In FIG. 2, various users with their own ledger blocks 220 may store data in Blockchain, through their HPAs as provided by the back end system administrator 202. The users could be any number of institutions such as but not limited to a university, government entity, or any other institution or individual. In this way, because these approved users 206 are allowed to write to blocks 220, for example, a university adding grade information about a particular student, the back end system 202 has access to any and all of these blocks 220 of data.

Not only can the Blockchain work as discussed in FIG. 1, to save and store data in a ledger, but so called smart contracts may be arranged, using the Blockchain architecture, to utilize and search the underlying data in the ledgers. Through this interface 240, employers and academic institutions may request verification of the data in the underlying ledgers. The system 202 may then run those verifications through the users 206 and report back or notify the third parties 250.

The application program interface (API) 240 through which third parties 250 interact with and request data may be hosted by and controlled by the back end system 202. In one examples, third parties such as employers 250 looking to access the information from the VBP platform may do so through an application interface 240 hosted by the back end system 202. This is the underlying data that employers and other stakeholders 206 have written information, for example, CV data. The application interface 240 may be on any of various platforms including but not limited to a mobile App on a mobile device, a streaming web service, a browser implemented system, or any combination of these. This API may be provided through any web interface, and is not the same as the HPA construct, which is a virtually instantiated machine which is only issued by the back end system 202 to allow verified users 206 to write to blocks 220. Instead, this API 240 is public and forward facing. Through this API 240, any member of the public may query the system 202 for various information, which may be researched and found in the underlying block ledgers 220. In some example embodiments, because the back end system 202 controls the information flow, it may charge money or subscription fees for this data access. In various examples, the back end system administrators 202 may arrange for the API 240 to charge for access, and interface with the third parties 250 in receiving queries.

As described, the back end users 206 and even more granularly, the users about whom the data is written, may control the information that is allowed to be shared by the back end system 202 with third parties 250. Through use of role based securities and access control lists, participant users 206 can control what information they want to publish to the network and have shared in any of various customizable selections.

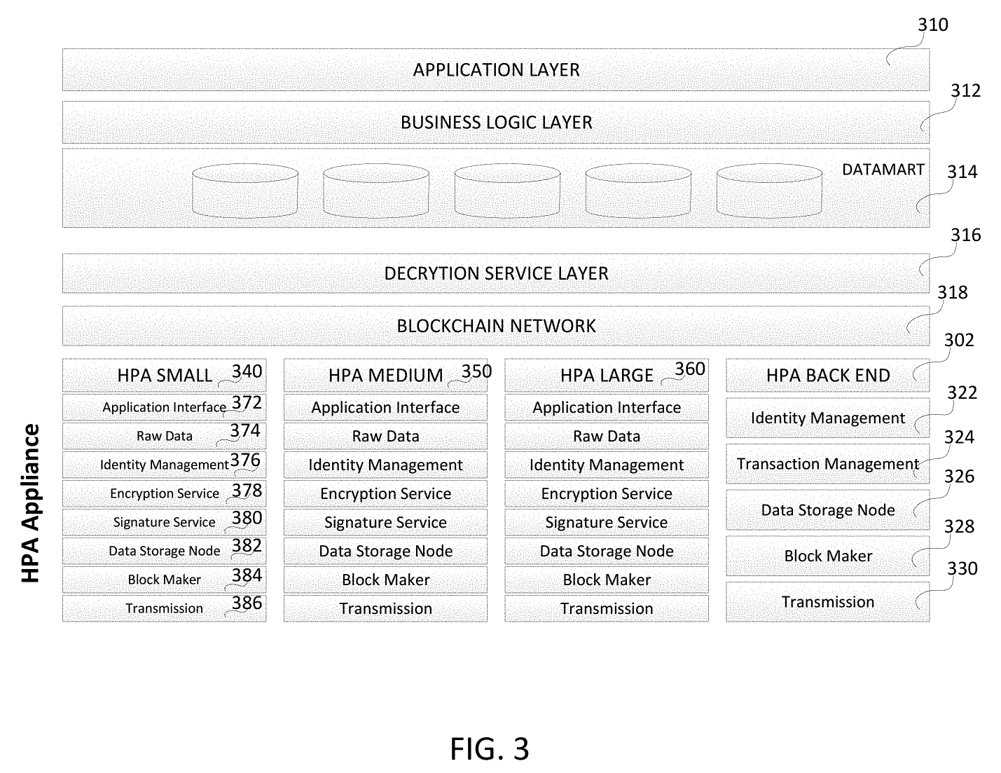

FIG. 3 shows an example architecture diagram, according to some embodiments described herein. The system could use a cloud instance such as AZURE or GCP to instantiate the services including the virtual machines HPAs as described herein. In the example, the application layer 310 such as AngularJS, D3JS, or others, is shown interfacing with a business logic layer 312. An NGiVX webserver and load balancer may be utilized. The data storage layer 314 could be any kind of networked, decentralized data storage device on servers and databases for node storage for the Blockchain as described herein. NodeJS, PostGres could be used as the back end. The data storage layer 314 is shown interfacing with the business logic layer 312 and the decryption service layer 316 which allows for decryption of the Blockchain ledgers. Examples of the Blockchain implementation may include Quorum or Tendermint. Thus, the decryption service layer 316 interfaces with the Blockchain network 318 itself. Encryption algorithms may use Asymmetric Encryption Algorithms to encrypt the blocks.

FIG. 3 also shows a depiction of the back end system HPA 302. This back end system 302 interfaces with the Blockchain network 318 as described herein. In the example of FIG. 3, the back end systems include management of various facilities including but not limited to identity management 322 of which entities are allowed HPAs to write to blocks, transaction management 324 of the ledgers, data storage node(s) 326, block maker 328 for the ledgers and transmission 330 of the blocks to the nodes. The back end systems 302 may be able to host one of these decentralized nodes on a distributed database (cloud network) to have continuous information availability.

As described herein and as shown in FIG. 3, blockchain data storage services may be provided in different levels. For examples, appliance packaged as, HPA SMALL 340, HPA MEDIUM 350 or HPA LARGE 360 service may be tailored for the individual needs of the third party wishing to write user data stored in the blockchain ledgers. Each of these tailored systems may utilize similar architecture for the blockchain, as described herein, but utilized differing amounts of data storage, number of participants, and ledgers used. The terms “small,” “medium,” and “large,” can correlate to any number of participants and data storage, and could be labeled in any way. The terms are arbitrary and merely used as an example to demonstrate the customizability for the services which may be offered using this platform. In the CV example, a small company may only have a few hundred employees, and therefore not need as much data storage, where as a huge entity with many hundreds of thousands or a million employees, may need much more infrastructure to store the data for their employees and therefore, blockchain resources to create ledgers as described herein. In some examples, consensus could be used as proof-of-authority.

For each of the service packages, various facilities may be utilized. FIG. 3 shows an example HPA 340 virtually instantiated machine which includes an application interface 372, the raw data 374 for the ledger entries, identity management 376, an encryption service 378 for writing to the encrypted blocks, signature service 380, data storage node 382 for data storage and for storing the blockchain ledgers, block maker 384 to write to the blocks, and transmission 386 of the blocks to the nodes. Identity management of network participants will happen through a unique public/private key generated for each HPA. Signature generation may be accomplished via Keccak256 or others.

In the example using CVs, through this blockchain architecture, smart contracts may be created for stakeholders to enter into an agreement to share their relevant CV information. In some examples, one entity 302 could be the single owner of the smart contract, the other stakeholder will be another owner of the smart contract as a network participant. Through such a smart contract, encryption services embedded inside the HPA virtual machine, information submitted by network participants will be encrypted and then published onto blockchain ledgers. And by using the decryption key, the back end management systems 302 will be able to decrypt the information at the application interface layer 310 to search and retrieve data from the block ledgers. The HPA 340 will physically save the private key for corresponding stakeholders and will be used for signing the transactions published to the Blockchain ledger.

Data Sharing Examples and Skills Passport Examples SPM

As described, the system platform may utilize a permissionless/permission hybrid architecture approach. The SPM system may thereby provide full control to users regarding how much data he/she wants to expose. For example, a user may share personal information & Diversity inclusion information like race, gender, minority, preference like belonging to LGBT group, etc.

In some examples, the systems and methods here may be used in a CV example as described. In such examples, a user's CV may include any number of skills passports, which could indicate in their blockchain CV, their credentials. This passport could tracks in far more detail, than is currently tracked, the things users do at work and school.

In some examples, some things that a skills passport could include in a ledger and thereby track could also be verified by an employer and/or academic institution. Examples include but are not limited to: work responsibilities; team leadership; ability to work across time zones; job title; job roles; job skills gained; job skills needed; systems used (e.g. ERP, CRM); key skills required for a role; foundational skills; behavior skills; cultural skills; extra curricular; volunteering hours; recruitment responsibilities, and many others.

Some examples of demographic information which may be included in a passport include, but are not limited to, age, gender, race, family history, location, and any social affiliated social or political groups such as religious, gender, or other societal organizations.

Some examples of the things in a passport that may be tracked and verified by an academic institution or school include but are not limited to, courses taken, scores or grades in each course, attendance, group presentation/work, teaching assistant (TA) roles, scholarships obtained, awards of recognition, professors' recommendations, extra curricular, credentials, society/club leadership roles, experience running meetup groups, public speaking, and many others.

Users may then determine which of these experience passport items they wish to reveal to different third parties. They may The key is that you as a student now have the power to unlock all or just parts of your data set to the public and or certain parties. For example, a user may set certain information available to all third parties, such as their high-level education and work history. Based on this information, third party employers could then request more detailed information such as roles, responsibilities, diversity inclusion information. This information could be provided using the Application Interface to employers and other entities. In such examples, the information sharing could be fully customizable and adaptable over time to individual circumstances that users wish to share.

Token/Coin Examples

In some examples, a Skills Passport Token (SPT) is a utility token or coin used to incentivize the learning based ecosystem. In such examples, gaining passport tokens or coins demonstrates increased educational and skills gained. This arrangement can help link and incentivize employees and employers to upskill their workers.

Such tokens or coins may be used in the smart contracts scenario to transact in a blockchain through only educational institutions. In some examples, all of the utility tokens or coins are pre-mined, and there would be no public ability to mine more tokens or coins. This allows the back end system administrator to define the upper limits of the number of Skill Tokens. The back end system administrator can then clearly define the role of the token or coin and how it works in the ecosystem.

In some examples, the smart contract can be utilized for this purpose. The smart contract was first proposed by the cryptographer Nick Szabo in 1994, only five years after the creation of the World Wide Web. According to Szabo's definition: when a pre-programmed condition is triggered, the smart contract will execute the corresponding contract terms. Blockchain technology, as described herein, provides a decentralized, tamper-resistant, highly reliable system in which smart contracts are very useful. SPT can be bought or given to any employee/student by the government/employer/friends and family or bought themselves. This allows them to use the token or coin to pay for and consume online or offline education. In such examples, the token or coin may be considered a utility token or coin, in that it cannot be spend on anything other than education to gain skills. SPT Tokens may be pre-mined and available for anyone to buy in the anticipation of using for education.

In some example embodiments, the system may enable a Skills Gap Analysis where a user can utilize a token/coin SPT to take a course and upskill, which will all them to automatically gain a verified addition to their blockchain ledger profile.

In some examples, schools may become partners. As students go through the system backed schools, they automatically have a SPT wallet and verified identity system SPM. The schools may give all those who complete a course, the appropriate number or portions of SPT tokens or coins to given them discounts on another course they recommend that they can trade. This incentivizes education in a new way.

In some examples, employers may become partners with the administrator of the back end server system. In such examples, employers could similarly offer SPT tokens or coins to their employees. These tokens or coins can be designed to expire and revert back to the employer if they are not used within a certain time period. Employers can also give SPT bonus tokens or coins if employees take courses that would be beneficial to the firm or their role.

In some examples, SPTs may become one of the incentives to attract new hires. For example, startup companies can give 5,000 to tokens or coins to new engineers upon joining the company. These utility tokens or coins, widely accepted by training schools all over the world, will be value for the new hire.

In some examples, other educational institutions may become partners with the administrator of the back end server system. In such examples, education institutions may offer, in both online and offline to accept SPT coins to consume courses. Such an arrangement may also be a way to measure accountability metrics by higher education.

In some examples, governments may become partners with the administrator of the back end server system. In such examples, governments may use the SPT tokens or coins to grant ongoing education to their employees or citizens, to target areas that are in need of upskilling. This will also allow governments to understand the return on investment of their citizens as it relates to income and skill mobility. As a result of having this data, it will allow governments to allocate budget accordingly. Lastly as they provide employers tax credit locally for hiring and upskilling they will now be able to measure outcomes.

Example Computing System

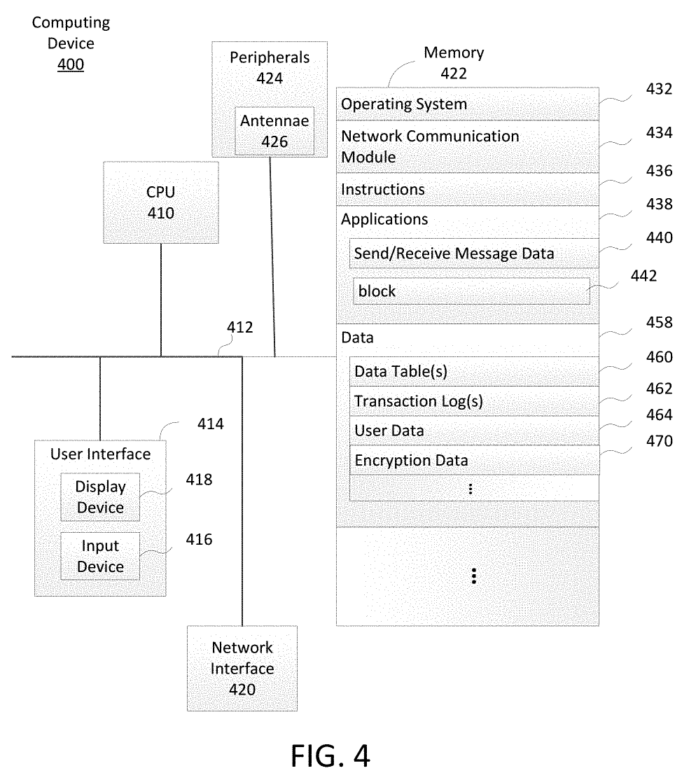

FIG. 4 shows an example computing system which may be used to implement the systems and methods described herein. For example, the back end server systems may include some or all of these computer components and be used as described herein to operate and manage the blockchain and smart contract systems. Third parties and users may utilize such systems in order to interface with and utilize the blockchain and smart contracts as described herein. The computing device 400 could be any kind of computing device such as but not limited to a mobile smartphone, laptop, desktop, wearable such as a watch or glasses, integrated unit in a car, airplane or other vehicle.

In the example of FIG. 4, the processor CPU 410 is in communication, by a bus 412 or other communication to various components such as but not limited to a user interface 414 which may include a display 418 and input device 416. Such display could be any kind of screen or microphone. Such input 416 could be any kind of touchscreen, keyboard, button(s), camera, motion detector, microphone, or other input. The computing system 400 includes a network interface 420 and peripherals 424 such as but not limited to an antennae 426 used to interact with and communication on a network using such standards as a WiFi, cellular, Bluetooth, NFC, or other network interface. The system 400 also includes a memory 422 used to carry out instructions for the processor 410. The memory 422 includes an operating system 432, network communication module 434, instructions 436, Applications such as sending and receiving data 440 and block creation 442. Data storage 458 may store data such as tables 460, transaction logs 462, user data 464 and encryption data 470 along with any other data storage needed.

### CONCLUSION

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The innovations herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the present inventions may be implemented via computer-hardware, software and/or firmware. For example, the network systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

What is claimed is:

1. A system, comprising,
a computer with a processor and memory, in communication with a network, the computer configured to,
provide access to a user to send curriculum vitae data into a profile, by the network,
wherein the profile is written as a blockchain ledger;
receive the curriculum vitae data of the user;
analyze the received curriculum vitae data for the user to determine a correlated third party associated with the curriculum vitae data;
contact the correlated third party, by the network, regarding the input curriculum vitae data for the user;
provide access to the third party, over the network to write to the blockchain ledger profile of the user;
disseminate the written blockchain ledger to a plurality of node computers, by the network.

2. The system of claim 1 wherein the access to the blockchain ledger is by a virtual machine.

3. The system of claim 1 wherein the blockchain ledger is encrypted.

4. The system of claim 1 further comprising a token, the token being issued by the computer, the token being configured to be utilized by the third party and thereby provide access to the third party, over the network to write to the blockchain ledger profile of the user.

5. The system of claim 1, wherein the computer is further configured to,
receive a query from a query user, by the network, the query regarding curriculum vitae data;
search the blockchain ledger of the user, using the received query;
send search results to the query user, by the network.

6. The system of claim 5 wherein the computer is further configured to,
receive curriculum vitae data of a plurality of other users;
search the blockchain ledgers of the user and the plurality of other users, using the received query; and
send search results to the query user, by the network.

7. The system of claim 6 wherein the computer is further configured to,
provide to the user, over the network, the ability to allow only a subset of the input curriculum vitae data to be found in a search.

8. A method, comprising,
by a computer with a processor and memory, in communication with a network, the computer,
providing access to a user to send curriculum vitae data into a profile, by the network,
wherein the profile is written as a blockchain ledger;
receiving the curriculum vitae data of the user;
analyzing the received curriculum vitae data for the user to determine a correlated third party associated with the curriculum vitae data;
contacting the correlated third party, by the network, regarding the input curriculum vitae data for the user;
providing access to the third party, over the network, to write to the blockchain ledger profile of the user;
disseminating the written blockchain ledger to a plurality of node computers, by the network.

9. The method of claim 8 wherein the access to the blockchain ledger is by a virtual machine.

10. The method of claim 8 wherein the blockchain ledger is encrypted.

11. The method of claim 8 wherein the third party is at least one of a university, school, company, or government entity.

12. The method of claim 8, wherein the computer is further configured to,
receive a query from a query user, by the network, the query regarding curriculum vitae data;
search the blockchain ledger of the user, using the received query;
send search results to the query user, by the network.

13. The method of claim 12 wherein the computer is further configured to,
receive curriculum vitae data of a plurality of other users;
search the blockchain ledgers of the user and the plurality of other users, using the received query; and
send search results to the query user, by the network.

14. The method of claim 13 wherein the computer is further configured to,
provide to the user, over the network, the ability to allow only a subset of the input curriculum vitae data to be found in a search.

15. A non-transitory computer readable medium having computer-executable instructions thereon for a method, comprising,
providing access to a user to send curriculum vitae data into a profile, by the network,
wherein the profile is written as a blockchain ledger;
receiving the curriculum vitae data of the user;
analyzing the received curriculum vitae data for the user to determine a correlated third party associated with the curriculum vitae data;
contacting the correlated third party, by the network, regarding the input curriculum vitae data for the user;
providing access to the third party, over the network, to write to the blockchain ledger profile of the user;
disseminating the written blockchain ledger to a plurality of node computers, by the network.

16. The non-transitory computer readable medium of claim 15 wherein the access to the blockchain ledger is by a virtual machine.

17. The non-transitory computer readable medium of claim 15 wherein the blockchain ledger is encrypted.

18. The non-transitory computer readable medium of claim 15 wherein the third party is at least one of a university, school, company, or government entity.

19. The non-transitory computer readable medium of claim 15, wherein the computer is further configured to,
receive a query from a query user, by the network, the query regarding curriculum vitae data;
search the blockchain ledger of the user, using the received query;
send search results to the query user, by the network.

20. The non-transitory computer readable medium of claim 19 wherein the computer is further configured to,
receive curriculum vitae data of a plurality of other users;
search the blockchain ledgers of the user and the plurality of other users, using the received query; and
send search results to the query user, by the network.
